(19) United States
(12) Patent Application Publication
(10) Pub. No.: US 2015/0181052 A1
(43) Pub. Date: Jun. 25, 2015

(54) INFORMATION PROCESSING SYSTEM, SCANNER, AND NON-TRANSITORY COMPUTER-READABLE MEDIUM

(71) Applicant: FUJI XEROX CO., LTD., Tokyo (JP)

(72) Inventor: Norio YAMAMOTO, Kanagawa (JP)

(73) Assignee: FUJI XEROX CO., LTD., Tokyo (JP)

(21) Appl. No.: 14/447,042

(22) Filed: Jul. 30, 2014

(30) Foreign Application Priority Data
Dec. 25, 2013 (JP) 2013-267991

(51) Int. Cl. H04N 1/00

(52) U.S. Cl. CPC H04N 1/0083; H04N 1/00347

(57) ABSTRACT

An information processing system to be connected to a scanner includes an image information acquiring unit, an exclusive-use information storage unit, and a print instruction unit. The image information acquiring unit acquires image information for identifying an exclusive-use user of the scanner. The exclusive-use information storage unit stores exclusive-use information in which exclusive-use user identification information for identifying the exclusive-use user is associated with the image information. The print instruction unit supplies an instruction to print the image information on a medium.

### CROSS-REFERENCE TO RELATED APPLICATIONS

This application is based on and claims priority under 35 USC 119 from Japanese Patent Application No. 2013-267991 filed Dec. 25, 2013.

### BACKGROUND

(i) Technical Field

The present invention relates to an information processing system, a scanner, and a non-transitory computer-readable medium.

(ii) Related Art

A known scanner is one which is connected to a network and which is shared by multiple clients. There has been arisen a problem with such a scanner in that, for example, during an operation of reading out a document for a user corresponding to one of the clients by using the scanner, it is impossible to read out documents for other users corresponding to the other clients.

### SUMMARY

According to an aspect of the present invention, there is provided an information processing system to be connected to a scanner. The information processing system includes an image information acquiring unit, an exclusive-use information storage unit, and a print instruction unit. The image information acquiring unit acquires image information for identifying an exclusive-use user of the scanner. The exclusive-use information storage unit stores exclusive-use information in which exclusive-use user identification information for identifying the exclusive-use user is associated with the image information. The print instruction unit supplies an instruction to print the image information on a medium.

### BRIEF DESCRIPTION OF THE DRAWINGS

Exemplary embodiment of the present invention will be described in detail based on the following figures, wherein:

FIG. 1 is a diagram for describing an exemplary overall configuration of a service providing system;

FIG. 2 is a diagram for describing an exemplary functional configuration of a service providing apparatus;

FIG. 3 is a diagram illustrating an example of how to store exclusive-use information in an exclusive-use information storage unit;

FIG. 4 is a diagram for describing an exemplary functional configuration of a scanner;

FIG. 5 is a flowchart illustrating an exemplary process flow of the service providing apparatus; and

FIG. 6 is a flowchart illustrating an exemplary flow of the scanner.

### DETAILED DESCRIPTION

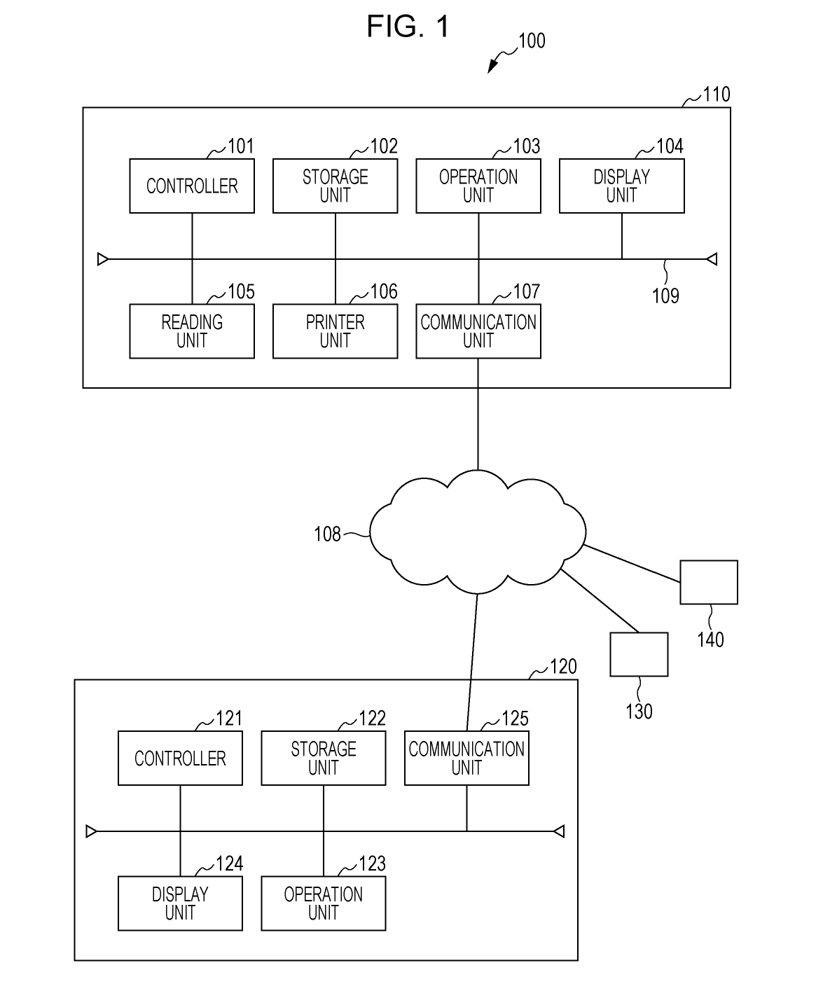

FIG. 1 is a diagram illustrating an overview of the overall configuration of a service providing system according to an exemplary embodiment of the present invention. As illustrated in FIG. 1, a service providing system 100 according to the exemplary embodiment includes, for example, a scanner 110, a terminal apparatus 120, a service providing apparatus 130, and an external service providing apparatus 140.

The scanner 110 is, for example, a multi-function device having a copy function, a scan function, and the like. As illustrated in FIG. 1, the scanner 110 includes, for example, a controller 101, a storage unit 102, an operation unit 103, a display unit 104, a reading unit 105, a printer unit 106, and a communication unit 107. The units 101 to 107 are connected to each other via an internal bus 109.

The controller 101, which is, for example, a microprocessor unit (MPU), operates according to programs stored in the storage unit 102. The storage unit 102, which is constituted by an information recording medium, such as a read-only memory (ROM), a random-access memory (RAM), or a hard disk, is an information recording medium which holds programs executed by the controller 101. The storage unit 102 also operates as a work memory of the controller 101. For example, the programs may be provided by downloading them via a network, or may be provided through various types of computer-readable information recording media, such as a compact disk read-only memory (CD-ROM) and a digital versatile disk read-only memory (DVD-ROM).

The operation unit 103, which is constituted by interfaces, such as buttons and a touch panel displayed on the display unit 104 described below, outputs information about an operation performed by a user giving an instruction, to the controller 101 in response to the operation. The display unit 104, which is a liquid crystal display, an organic electroluminescence (EL) display, or the like, displays information in accordance with an instruction transmitted from the controller 101.

The reading unit 105, for example, scans the surface of a medium by using an imaging sensor, thereby reading out characters, figures, and the like which are drawn on the surface of the medium. For example, the reading unit 105 includes a feeding apparatus which feeds multiple sheets of media one by one to the reading unit 105.

The printer unit 106 prints, for example, an image obtained by the reading unit 105 or an image stored in the storage unit 102. The communication unit 107 connects the scanner 110 to the terminal apparatus 120, the service providing apparatus 130, the external service providing apparatus 140, and the like via a network 108.

The terminal apparatus 120, which is, for example, a so-called client, includes a controller 121, a storage unit 122, an operation unit 123, a display unit 124, and a communication unit 125. Each of the service providing apparatus 130 and the external service providing apparatus 140, which is, for example, a server, includes the controller 121, the storage unit 122, and the communication unit 125 (not illustrated). The configurations of the controller 121, the storage unit 122, the operation unit 123, the communication unit 125, the display unit 124, and the like which are described above are similar to those of the controller 101, the storage unit 102, the operation unit 103, the display unit 104, the communication unit 107, and the like of the scanner 110 described above, and will not be described.

The configuration of the service providing system 100 illustrated in FIG. 1 as described above is an example. The exemplary embodiment is not limited to this. For example, the service providing apparatus 130 and the external service providing apparatus 140 may be achieved as a so-called cloud. For the sake of simplicity, in FIG. 1, only one terminal apparatus 120 is illustrated. It goes without saying that a configuration may be employed in which multiple terminal apparatuses 120 are connected.

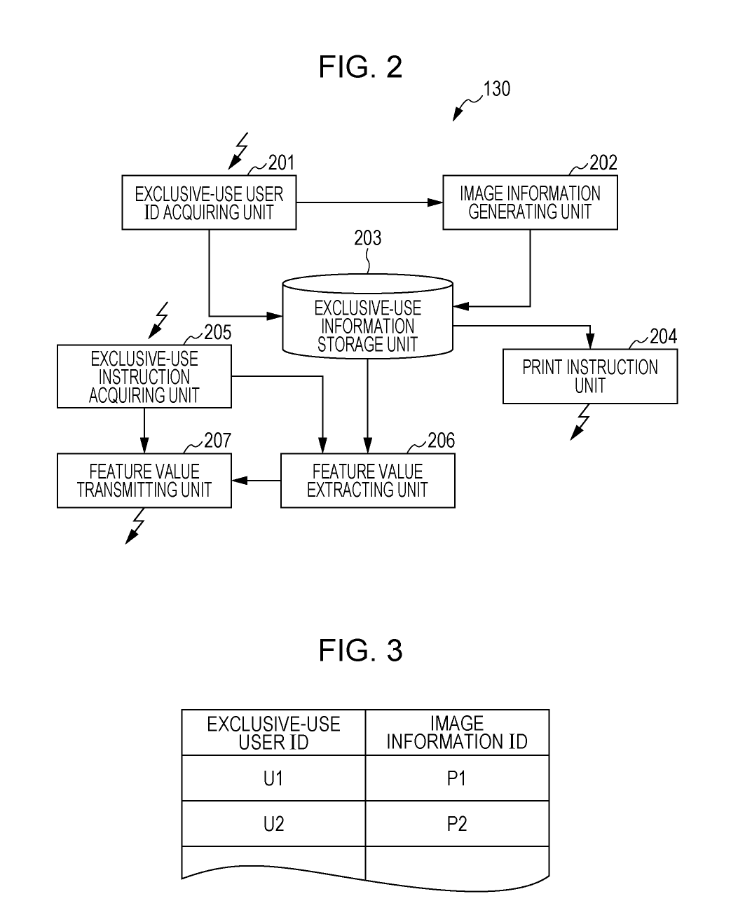

FIG. 2 is a diagram for describing an exemplary functional configuration of a service providing apparatus according to the exemplary embodiment. As illustrated in FIG. 2, the service providing apparatus 130 includes, for example, an exclusive-use user ID acquiring unit 201, an image information generating unit 202, an exclusive-use information storage unit 203, a print instruction unit 204, an exclusive-use instruction acquiring unit 205, a feature value extracting unit 206, and a feature value transmitting unit 207.

The exclusive-use user ID acquiring unit 201 acquires exclusive-use user identification information (exclusive-use user ID) for identifying the exclusive-use user who exclusively uses the scanner 110. Specifically, for example, the exclusive-use user ID acquiring unit 201 acquires an exclusive-use user ID from the terminal apparatus 120 via the network 108.

The exclusive-use user ID corresponds to, for example, the user ID for identifying a user, or the IP address of the terminal apparatus 120 used by a user. The user ID is input when the service providing apparatus 130 or the like registers a new user, and the exclusive-use user ID acquiring unit 201 acquires the user ID which is input. For the sake of simplicity, description will be made below by taking a case in which the exclusive-use user ID corresponds to a user ID, as an example.

The image information generating unit 202 generates image information corresponding to the obtained exclusive-use user ID. As long as the exclusive-use user ID is identifiable on the basis of the image information, the image information may be, for example, image information in which some of the characters of the user ID are arranged, or may be a two-dimensional code such as a so-called quick response (QR) Code®, or a barcode. In addition, for example, the image information generating unit 202 generates the image information upon registration of a new user. Further, the image information is generated for each of exclusive-use user IDs.

The exclusive-use information storage unit 203, for example, associates an exclusive-use user ID with the image information generated in accordance with the exclusive-use user ID, so as to store the resulting data as exclusive-use information. Specifically, for example, as illustrated in FIG. 3, the exclusive-use information storage unit 203 stores a table which describes an association between each of the exclusive-use user IDs and image identification information (image information ID) for identifying image information generated for the exclusive-use user ID. More specifically, for example, FIG. 3 illustrates how to store associations between exclusive-use user IDs, U1 and U2, and image information IDs, P1 and P2, for identifying image information generated for the exclusive-use user IDs, U1 and U2, when the user IDs, U1 and U2, are registered as a new user. In the description below, a user identified with the user ID of U1 is called a first user, and a user identified with the user ID of U2 is called a second user.

The print instruction unit 204 supplies an instruction to print image information generated by the image information generating unit 202. Specifically, for example, the print instruction unit 204 may supply a print instruction to the printer unit 106 when the image information generating unit 202 generates image information, or may supply a print instruction to the printer unit 106 in response to an instruction transmitted from a user before an exclusive-use instruction which is described below is given by the user. The printer unit 106 may be the printer unit 106 of the scanner 110, or may be a printer (not illustrated) which is another printer connected to the scanner 110 and which has a print function.

The exclusive-use instruction acquiring unit 205 obtains an exclusive-use instruction that the user exclusively use the scanner 110. The exclusive-use instruction includes, for example, an exclusive-use user ID for identifying the user. The exclusive-use instruction is obtained from the terminal apparatus 120 used by the user via the network 108.

The feature value extracting unit 206 extracts a feature value of image information stored in the image information storage unit 203, from the image information. Specifically, the feature value extracting unit 206 obtains image information stored in such a manner that the image information is associated with the exclusive-use user identification information, from the exclusive-use information storage unit 203 on the basis of the exclusive-use user ID included in the exclusive-use instruction acquired by the exclusive-use instruction acquiring unit 205. Then, the feature value extracting unit 206 extracts a feature value from the image information. The feature value may be, for example, a feature value from the user ID or the IP address. As long as the feature value allows the corresponding exclusive-use user to be identified, the feature value may be a feature value from another data. Description will be made below by taking a case in which the feature value is one from a user ID, as an example.

Specifically, for example, in the case illustrated in FIG. 3, when the exclusive-use instruction includes the exclusive-use user ID of U1, the feature value extracting unit 206 obtains the image information ID of P1 stored in such a manner that the image information ID of P1 is associated with the exclusive-use user ID of U1, and extracts a feature value U1 from the image information identified with the image information ID of P1.

The feature value transmitting unit 207 transmits the feature value extracted by the feature value extracting unit 206, along with the exclusive-use instruction to the scanner 110. For example, in the above-described case, the feature value transmitting unit 207 transmits the exclusive-use user ID of U1 and the feature value U1 to the scanner 110.

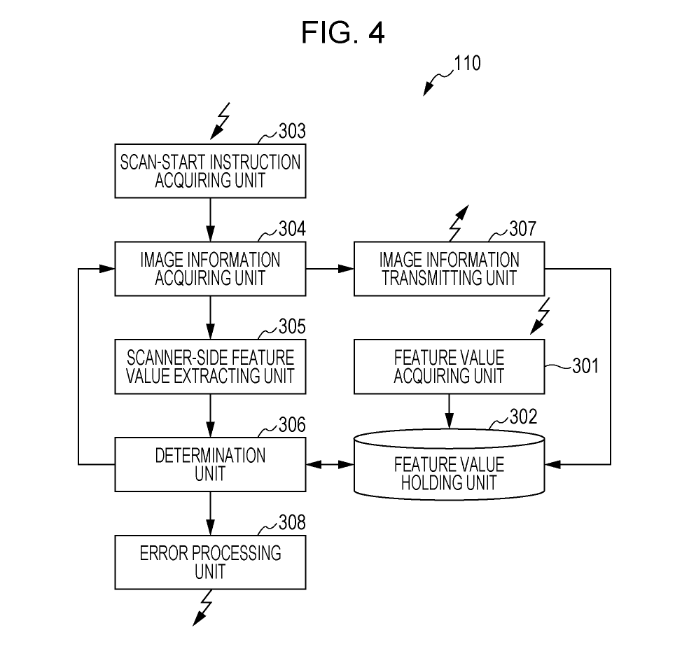

An exemplary functional configuration of the scanner 110 according to the present exemplary embodiment will be described by using FIG. 4. To make it easy to understand the description below, as in the above-described example, a case in which the feature value U1 is transmitted from the service providing apparatus 130 along with an exclusive-use instruction including the exclusive-use user ID of U1 will be described as an example.

As illustrated in FIG. 4, the scanner 110 includes, for example, a feature value acquiring unit 301, a feature value holding unit 302, a scan-start instruction acquiring unit 303, an image information acquiring unit 304, a scanner-side feature value extracting unit 305, a determination unit 306, an image information transmitting unit 307, and an error processing unit 308.

The feature value acquiring unit 301 acquires the exclusive-use instruction and the feature value which are transmitted from the feature value transmitting unit 207. In the case of the above-described example, for example, the feature value acquiring unit 301 acquires the exclusive-use user ID of U1 and the feature value U1.

The feature value holding unit 302 holds the exclusive-use user ID and the feature value acquired by the feature value acquiring unit 301. Specifically, for example, when the feature value holding unit 302 does not hold an exclusive-use user ID and a feature value, the feature value holding unit 302 holds the exclusive-use user ID and the feature value acquired by the feature value acquiring unit 301. For example, in the case where the feature value holding unit 302 already holds the exclusive-use user ID of U1 and the feature value U1, when the feature value acquiring unit 301 newly acquires the exclusive-use user ID of U2 and a feature value U2, the feature value holding unit 302 does not hold the exclusive-use user ID of U2 and the feature value U2. That is, the user identified with the exclusive-use user ID held by the feature value holding unit 302 is the current exclusive-use user of the scanner 110. That is, in the case of the above-described example, for example, at a timing when the feature value holding unit 302 holds the exclusive-use user ID and the feature value, exclusive use of the scanner 110 which is granted to the user (first user) identified with the exclusive-use user ID of U1 is started.

The scan-start instruction acquiring unit 303 obtains a scan start instruction. Specifically, for example, a user sets multiple sheets of document on the reading unit 105, and then inputs a scan start instruction to the operation unit 103 of the scanner 110, whereby the scan-start instruction acquiring unit 303 acquires the scan start instruction. For example, the user sets the multiple sheets of document in such a manner that a sheet on which image information is printed is read out as the first page by the reading unit 105. That is, in the case of the above-described example, the user places a sheet of document on which the image information identified with the image information ID of P1 is printed, as the first page.

The reading unit 105 reads out the first page of the document in response to the scan start instruction acquired by the scan-start instruction acquiring unit 303. The image information acquiring unit 304 acquires the image information of the first page from the reading unit 105. In addition, the reading unit 105 reads out the second page and its subsequent pages of the document in accordance with the determination result made by the determination unit 306 described below, and the image information acquiring unit 304 acquires image information of the second page and its subsequent pages of the document.

The scanner-side feature value extracting unit 305 extracts a feature value from the image information of the first page which is acquired by the image information acquiring unit 304. For example, in the case of the above-described example, the scanner-side feature value extracting unit 305 extracts the feature value U1 from the image information printed on the first page of the document.

The determination unit 306 determines whether or not the user who has set the multiple sheets of document as described above and who has given the scan start instruction is the proper current exclusive-use user of the scanner 110. Specifically, on the basis of the feature value (first feature value) held by the feature value holding unit 302 and the feature value (second feature value) extracted by the scanner-side feature value extracting unit 305, the determination unit 306 determines whether or not the exclusive-use user (first exclusive-use user) identified with the first feature value is identical to the exclusive-use user (second exclusive-use user) identified with the second feature value. In the case of the above-described example, the first feature value is U1, and the second feature value is also U1. Accordingly, the first feature value is equal to the second feature value. Therefore, it is determined that the user is the proper exclusive-use user.

If the determination unit 306 determines that the first exclusive-use user is identical to the second exclusive-use user, the reading unit 105 starts reading out the second page and its subsequent pages of the document, and the image information acquiring unit 304 acquires image information of the second page and its subsequent pages of the document. The image information transmitting unit 307 transmits the image information of the second page and its subsequent pages of the document to a predetermined destination. The destination corresponds to, for example, the external service providing apparatus 140. After transmission of the image information, the feature value holding unit 302 deletes the exclusive-use user ID and the feature value which are held by the feature value holding unit 302, whereby exclusive use of the scanner 110 which has been granted to the exclusive-use user identified with the exclusive-use user ID is released. For example, when the feature value acquiring unit 301 newly acquires the exclusive-use user ID of U2 and the feature value U2, the feature value holding unit 302 holds the exclusive-use user ID of U2 and the feature value U2. In other words, exclusive use of the scanner 110 is now granted to the user identified with the exclusive-use user ID of U2.

If the determination unit 306 determines that the user is not the proper exclusive-use user, the error processing unit 308 performs a predetermined error process. Specifically, for example, when the user (second user) identified with the user ID of U2 gives a scan start instruction to scan multiple sheets of document including a sheet on which image information from which the feature value U2 is extracted is printed, the scanner-side feature value extracting unit 305 extracts the feature value U2. In the case of the above-described example, the feature value holding unit 302 holds the feature value U1. Therefore, the determination unit 306 determines that the first and second feature values are not the same, and performs the error process.

In the error process, the second page and its subsequent pages of the document are not read out, and the user (for example, the second user) who has set the document or the current exclusive-use user (first user) of the scanner 110 is notified that a user other than the current exclusive-use user has given a scan instruction. More specifically, for example, a message that a user other than the current exclusive-use user has given a scan instruction, the user name of the user other than the exclusive-use user, and the like may be displayed on the display unit 104 and/or the display unit 124. Alternatively, such information may be transmitted to the user who is the exclusive-use user by electronic mail.

In this case, the exclusive use of the scanner 110 is continued. That is, the feature value holding unit 302 continues to hold the exclusive-use user ID and the feature value which are being held. For example, in the case of the above-described example, the feature value holding unit 302 continues to hold the exclusive-use user ID of U1 and the feature value U1. Therefore, for example, when the first user who is the proper user causes a document on which the image information identified with the image information ID of P1 is printed to be read out, the feature values are the same value, U1, as described above, and the first user is therefore permitted to scan the multiple sheets of document.

The above-described functional configurations of the service providing apparatus 130 and the scanner 110 illustrated in FIGS. 2 and 3 are examples, and the exemplary embodiment is not limited to these. For example, a part of the functional configurations of the service providing apparatus 130 and the scanner 110 illustrated in FIGS. 2 and 3 may be achieved by using a cloud. For example, in the description, the case in which the scanner 110 is provided with the scanner-side feature value extracting unit 305 and the determination unit 306 is described. The scanner-side feature value extracting unit 305 and/or the determination unit 306 may be provided for the service providing apparatus 130, or may be provided for an external apparatus connected via the network 108.

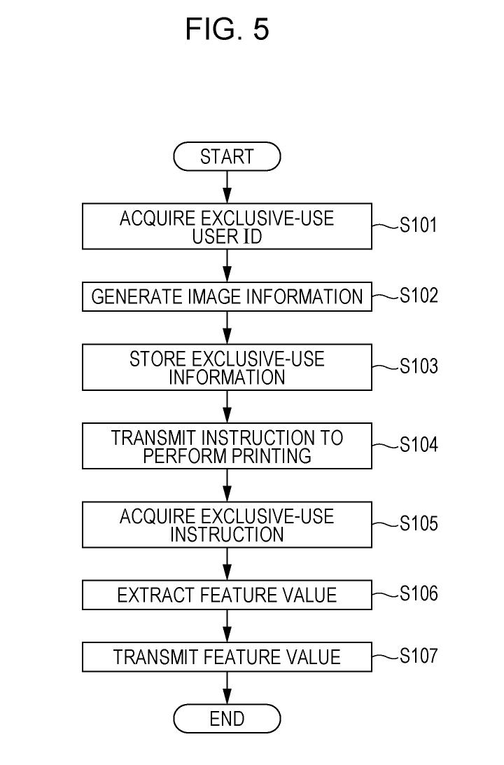

An exemplary flow of a process performed by the service providing apparatus 130 will be described by using FIG. 5. The flow of the process performed by the service providing apparatus 130, which is described below, is an example, and the exemplary embodiment is not limited to this.

The exclusive-use user ID acquiring unit 201 acquires an exclusive-use user ID with which the exclusive-use user of the scanner 110 is identified (S101). The image information generating unit 202 generates image information according to the exclusive-use user ID obtained in step S101 (S102). The exclusive-use information storage unit 203 stores the exclusive-use user ID and the image information generated in accordance with the exclusive-use user ID, as exclusive-use information, in such a manner that the exclusive-use user ID and the image information are associated with each other (S103). The print instruction unit 204 instructs the printer unit 106 to print the image information generated by the image information generating unit 202 (S104).

For the sake of simplicity, in the above-described processes from step S101 to step S104, an exemplary actual pre-process until an instruction to start exclusive use of the scanner 110 is transmitted is illustrated under the assumption that the number of users is one. Therefore, for example, when the number of users is more than one, the processes from step S101 to step S104 are performed for each of the users. The process in step S104 may be performed at another timing, e.g., when an instruction to start exclusive use of the scanner 110, which is described below, is transmitted.

The exclusive-use instruction acquiring unit 205 acquires an exclusive-use instruction that the user exclusively use the scanner 110 (S105). The feature value extracting unit 206 extracts a feature value of the image information stored in the image information storage unit 203, from the image information (S106). The feature value transmitting unit 207 transmits the feature value extracted by the feature value extracting unit 206, along with the exclusive-use instruction to the scanner 110 (S107).

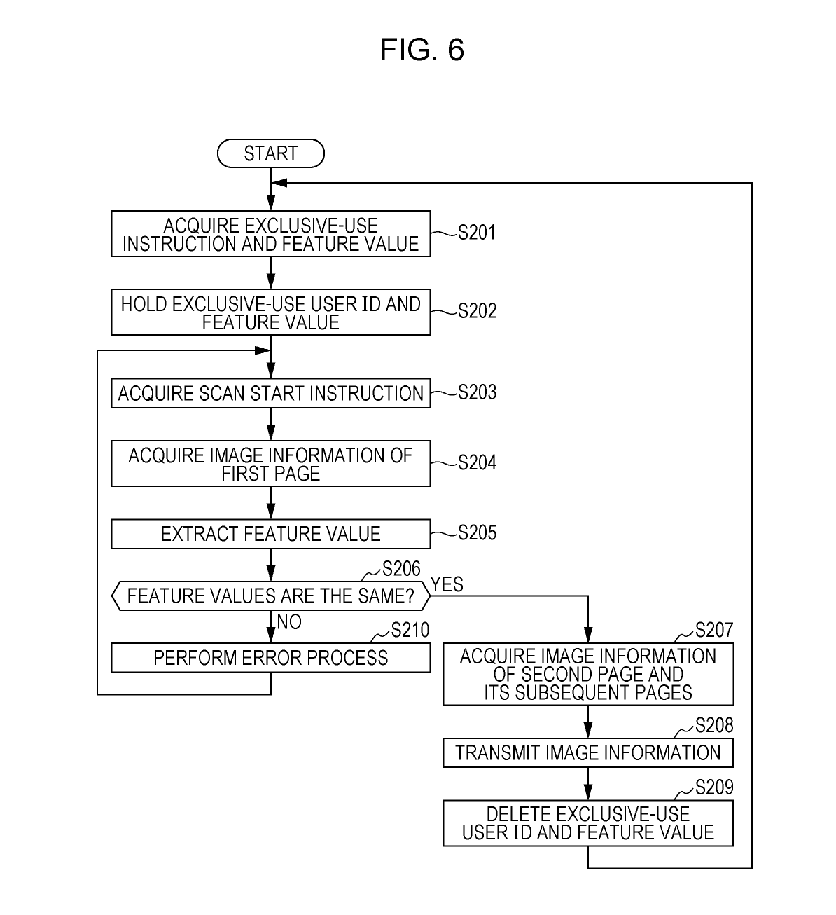

The flow of the scanner 110 will be described by using FIG. 6. First, the feature value acquiring unit 301 acquires the exclusive-use instruction and the feature value transmitted from the feature value transmitting unit 207 (S201).

If the feature value holding unit 302 does not hold an exclusive-use user ID and a feature value, the feature value holding unit 302 holds the exclusive-use user ID and the feature value which are acquired by the feature value acquiring unit 301 in step S201 (S202). If the feature value holding unit 302 already holds an exclusive-use user ID and a feature value, the feature value holding unit 302 continues to hold the exclusive-use user ID and the like which are being held.

The scan-start instruction acquiring unit 303 acquires a scan start instruction (S203). The reading unit 105 reads out the first page of a document in response to the scan start instruction acquired by the scan-start instruction acquiring unit 303, and the image information acquiring unit 304 acquires image information of the first page from the reading unit 105 (S204). The scanner-side feature value extracting unit 305 extracts a feature value from the image information of the first page which is acquired by the image information acquiring unit 304 in step S204 (S205).

The determination unit 306 determines whether or not the feature value held by the feature value acquiring unit 302 is equal to the feature value extracted in step S205 (S206). If it is determined that the feature values are the same in step S206, the reading unit 105 starts scanning the second page and its subsequent pages of the document, and the image information acquiring unit 304 acquires image information of the second page and its subsequent pages of the document (S207). The image information transmitting unit 307 transmits the image information of the second page and its subsequent pages of the document to the predetermined destination (S208). The feature value holding unit 302 deletes the exclusive-use user ID and the feature value which are being held (S209). The process proceeds to step S201, and a new exclusive-use instruction and the like are obtained. In contrast, if it is determined that the feature values are not the same in step S206, the error processing unit 308 performs the predetermined error process (S210). The process returns back to step S203, and exclusive use is continuously granted to the current exclusive-use user.

The above-described flows of the processes performed by the scanner 110 and the service providing apparatus 130 are merely examples, and the exemplary embodiment is not limited to these. For example, as described above, the feature value holding unit 302 may hold a feature value and the like at a timing when a scan start instruction is obtained. In other words, exclusive use of the scanner 110 may be started at a timing when a scan start instruction is received. As described above, description is made by taking, as an example, the case in which image information obtained through scanning is transmitted when it is determined that the user is the proper exclusive-use user. For example, the exemplary embodiment may be applied to a process other than the above-described case, such as a process in which printing is performed in the scanner 110.

The present invention is not limited to the above-described exemplary embodiment, and the configuration described in the exemplary embodiment may be replaced with a configuration which is substantially the same as one described in the above-described exemplary embodiment, a configuration which exerts the same effects, or a configuration which achieves the same object.

As described above, for example, the case is described in which a user gives an exclusive-use instruction from the terminal apparatus 120 to the scanner 110. Alternatively, an instruction to reserve the exclusive use may be transmitted. In this case, for example, the feature value holding unit 302 holds multiple pairs of an exclusive-use user ID and a feature value. If one of the multiple feature values matches the feature value extracted by the scanner-side feature value extracting unit 305, exclusive use of the scanner 110 is granted to the user corresponding to the matched feature value, and a notification about this is transmitted to the terminal apparatus 120 of the user. If none of the multiple feature values matches the feature value extracted by the scanner-side feature value extracting unit 305, for example, the above-described error process is performed. In this case, the multiple pairs of an exclusive-use user ID and a feature value may be deleted one by one when a predetermined time period has elapsed from a time point when holding of each of the pairs is started.

As described above, the case is described in which, for example, the image information generating unit 202 generates image information for identifying the exclusive-use user in response to exclusive-use user identification information for identifying the exclusive-use user which is acquired by the exclusive-use user ID acquiring unit 201. However, the image information and the exclusive-use user identification information which are used to identify the exclusive-use user may be obtained, for example, on the basis of an ID card or the like including the image information.

An information processing system in the claims corresponds to, for example, the service providing apparatus 130. A feature value extracting unit included in a scanner described in the claims corresponds to, for example, the scanner-side feature value extracting unit 305. A determination result acquiring unit described in the claims corresponds to a unit that, for example, when the determination unit 306 is provided outside of the scanner 110, obtains a determination result from the determination unit 306 which is provided outside. Further, an image information acquiring unit in the claims may correspond to, for example, the image information generating unit 202, or may be a unit that obtains image information and exclusive-use user identification information which are used to identify the exclusive-use user on the basis of the above-described ID card or the like.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system to be connected to a scanner, the system comprising:
an image information acquiring unit that acquires image information for identifying an exclusive-use user of the scanner;
an exclusive-use information storage unit that stores exclusive-use information in which exclusive-use user identification information for identifying the exclusive-use user is associated with the image information; and
a print instruction unit that supplies an instruction to print the image information on a medium.

2. The information processing system according to claim 1, further comprising:
a feature value extracting unit that extracts a feature value for identifying the exclusive-use user, on the basis of the image information.

3. The information processing system according to claim 2, further comprising:
an exclusive-use instruction acquiring unit that acquires an exclusive-use instruction that exclusive use of the scanner be granted; and
a feature value transmitting unit that transmits the exclusive-use instruction and the feature value to the scanner in response to the exclusive-use instruction.

4. A scanner comprising:
an image information acquiring unit that acquires image information of a plurality of documents including a first document which are set on a reading unit; and
a determination result acquiring unit that acquires a determination result of whether or not a first exclusive-use user of the scanner matches a second exclusive-use user of the scanner, on the basis of a first feature value and a second feature value, the first feature value being extracted by a feature value extracting unit and being used to identify the first exclusive-use user on the basis of first image information of the first document, the second feature value being acquired by a feature value acquiring unit and being used to identify the second exclusive-use user,
wherein the image information acquiring unit acquires second image information of the plurality of documents in accordance with the determination result, the second image information excluding the first image information.

5. The scanner according to claim 4, further comprising:
the feature value extracting unit that extracts the first feature value for identifying the first exclusive-use user of the scanner on the basis of the first image information of the first document.

6. The scanner according to claim 4, further comprising:
the feature value acquiring unit; and
a determination unit that determines whether or not the first exclusive-use user matches the second exclusive-use user on the basis of the first feature value obtained by the feature value extracting unit and the second feature value acquired by the feature value acquiring unit,
wherein the determination result acquiring unit acquires the determination result obtained by the determination unit.

7. The scanner according to claim 5, further comprising:
the feature value acquiring unit; and
a determination unit that determines whether or not the first exclusive-use user matches the second exclusive-use user on the basis of the first feature value obtained by the feature value extracting unit and the second feature value acquired by the feature value acquiring unit,
wherein the determination result acquiring unit acquires the determination result obtained by the determination unit.

8. The scanner according to claim 4, further comprising:
an image information transmitting unit that transmits the second image information of the plurality of documents to a predetermined destination, the second image information excluding the first image information.

9. The scanner according to claim 5, further comprising:
an image information transmitting unit that transmits the second image information of the plurality of documents to a predetermined destination, the second image information excluding the first image information.

10. The scanner according to claim 6, further comprising:
an image information transmitting unit that transmits the second image information of the plurality of documents to a predetermined destination, the second image information excluding the first image information.

11. The scanner according to claim 7, further comprising:
an image information transmitting unit that transmits the second image information of the plurality of documents to a predetermined destination, the second image information excluding the first image information.

12. The scanner according to claim 4,
wherein the image information acquiring unit acquires the first image information of the first document when a scan start instruction is obtained, and the image information acquiring unit acquires the second image information of the plurality of documents when the determination result acquiring unit acquires a determination result that the first exclusive-use user matches the second exclusive-use user, the second image information excluding the first image information.

13. The scanner according to claim 4, further comprising:
an error processing unit that performs a predetermined error process when the determination result acquiring unit acquires a determination result that the first exclusive-use user does not match the second exclusive-use user.

14. A non-transitory computer readable medium storing a program causing a computer system to execute a process for information processing, the computer system being to be connected to a scanner, the process comprising:
acquiring image information for identifying an exclusive-use user of the scanner;
storing exclusive-use information in which exclusive-use user identification information for identifying the exclusive-use user is associated with the image information; and
supplying an instruction to print the image information on a medium.

15. A non-transitory computer readable medium storing a program causing a scanner to execute a process for scanning, the process comprising:
acquiring image information of a plurality of documents including a first document which are set on a reading unit; and
acquiring a determination result of whether or not a first exclusive-use user of the scanner matches a second exclusive-use user of the scanner, on the basis of a first feature value and a second feature value, the first feature value being extracted in an extraction process and being used to identify the first exclusive-use user on the basis of first image information of the first document, the second feature value being acquired in an acquiring process and being used to identify the second exclusive-use user,
wherein, in the acquiring process, second image information of the plurality of documents is acquired in accordance with the determination result, the second image information excluding the first image information.
